(19) United States
(12) Patent Application Publication
(10) Pub. No.: US 2022/0281451 A1
(43) Pub. Date: Sep. 8, 2022

(54) TARGET VEHICLE STATE IDENTIFICATION FOR AUTOMATED DRIVING ADAPTATION IN VEHICLES CONTROL

(71) Applicant: GM GLOBAL TECHNOLOGY OPERATIONS LLC, Detroit, MI (US)

(72) Inventors: Alaeddin Bani Milhim, Ajax (CA); Mohammadali Shahriari, Markham (CA); Ming Zhao, Northville, MI (US)

(73) Assignee: GM GLOBAL TECHNOLOGY OPERATIONS LLC, Detroit, MI (US)

(21) Appl. No.: 17/192,644

(22) Filed: Mar. 4, 2021

(51) Int. Cl. B60W 30/16; B60W 40/04; G06K 9/00; H04W 4/44; H04W 4/46

(52) U.S. Cl. CPC B60W 30/162; B60W 40/04; G06K 9/00825; H04W 4/44; H04W 4/46; B60W 2554/802; B60W 2520/105; B60W 2556/65

(57) ABSTRACT

In exemplary embodiments, methods, systems, and vehicles are provided that include: one or more sensors that are configured to at least facilitate obtaining sensor data with one or more indications pertaining to a target vehicle that is travelling ahead of the vehicle along a roadway; and a processor that is coupled to the one or more sensors and that is configured to at least facilitate: determining an initial estimated value of acceleration for the target vehicle, based on the one or more indications pertaining to the target vehicle; and controlling a vehicle action for the vehicle based at least in part on the initial estimated value of the acceleration based on the one or more indications pertaining to the target vehicle.

### TECHNICAL FIELD

The technical field generally relates to vehicles and, more specifically, to methods and systems for controlling vehicles based on information for target vehicles in front of the vehicle.

### BACKGROUND

Certain vehicles today are equipped to have one or more functions controlled based on conditions of a roadway on which the vehicle is travelling. However, such existing vehicles may not always provide optimal control of the vehicle in certain situations.

Accordingly, it is desirable to provide improved methods and systems for controlling vehicles based on targets in front of the vehicle. Furthermore, other desirable features and characteristics of the present invention will become apparent from the subsequent detailed description of the invention and the appended claims, taken in conjunction with the accompanying drawings and this background of the invention.

### SUMMARY

In an exemplary embodiment, a method is provided that includes: obtaining, via one or more sensors of a host vehicle, one or more indications pertaining to a target vehicle that is travelling ahead of the host vehicle along a roadway; determining, via a processor of the host vehicle, an initial estimated value of acceleration and states for the target vehicle, based on the one or more indications pertaining to the target vehicle; and controlling, via instructions provided by the processor, a vehicle action for the host vehicle based at least in part on the initial estimated value of the acceleration and other states of the vehicle based on the one or more indications pertaining to the target vehicle.

Also in an exemplary embodiment, the step of obtaining the one or more indications includes obtaining the one or more indications based on camera images from a camera onboard the host vehicle.

Also in an exemplary embodiment, the step of obtaining the one or more indications includes obtaining cameras images, from the camera onboard the host vehicle, as to one or more brake lights of the target vehicle; and the step of determining the initial estimated value of acceleration for the target vehicle includes determining the initial estimated value of acceleration for the target vehicle based on the brake lights of the target vehicle.

Also in an exemplary embodiment, the step of obtaining the one or more indications includes obtaining the one or more indications based on vehicle to vehicle communications between the host vehicle and one or more other vehicles.

Also in an exemplary embodiment, the step of obtaining the one or more indications includes obtaining the one or more indications based on vehicle to vehicle to infrastructure communications between the host vehicle and one or more infrastructure components of the roadway.

Also in an exemplary embodiment, the step of obtaining the one or more indications includes obtaining information as to a signal provided by the target vehicle; and the step of determining the initial estimated value of acceleration for the target vehicle includes determining the initial estimated value of acceleration for the target vehicle based on the signal provided by the target vehicle.

Also in an exemplary embodiment, the step of obtaining the one or more indications includes obtaining information as to a turn signal provided by the target vehicle; and the step of determining the initial estimated value of acceleration for the target vehicle includes determining the initial estimated value of acceleration for the target vehicle based on the turn signal provided by the target vehicle.

Also in an exemplary embodiment, the step of obtaining the one or more indications includes information pertaining to a traffic signal in proximity to the target vehicle; and the step of determining the initial estimated value of acceleration for the target vehicle includes determining the initial estimated value of acceleration for the target vehicle based on the traffic signal.

Also in an exemplary embodiment, the step of obtaining the one or more indications includes information pertaining to a traffic signal in proximity to the target vehicle; and the step of determining the initial estimated value of acceleration for the target vehicle includes determining the initial estimated value of acceleration for the target vehicle based on the traffic signal.

Also in an exemplary embodiment, the step of obtaining the one or more indications includes information pertaining to an additional vehicle in front of the target vehicle along the roadway; and the step of determining the initial estimated value of acceleration for the target vehicle includes determining the initial estimated value of acceleration for the target vehicle based on the information pertaining to the additional vehicle.

Also in an exemplary embodiment, the step of controlling the vehicle action includes controlling, via the processor, a longitudinal acceleration of the host vehicle based on the initial estimated value of acceleration for the target vehicle.

Also in an exemplary embodiment, the step of controlling the longitudinal acceleration includes controlling, via the processor, the longitudinal acceleration of the host vehicle as part of an adaptive cruise control functionality of the host vehicle based on initial estimated value of acceleration for the target vehicle.

Also in an exemplary embodiment, the method further includes: receiving updated sensor data with respect to the target vehicle via one or more additional sensors of the host vehicle; receiving updated sensor data with respect to the target vehicle via one or more additional sensors of the host vehicle; applying, via the processor, a correction to the initial estimated value of acceleration for the target vehicle, based on the updated sensor data; and controlling, via the instructions provided by the processor, the vehicle action based on the correction to the initial estimated value of acceleration for the target vehicle.

Also in an exemplary embodiment, wherein the step controlling the vehicle action includes controlling the vehicle action, via the instructions provided by the processor, based on the initial value of acceleration of the target vehicle, in a manner that mimics a human driver.

In another exemplary embodiment, a system is provided that includes: one or more sensors of a host vehicle that are configured to at least facilitate obtaining sensor data with one or more indications pertaining to a target vehicle that is travelling ahead of the host vehicle along a roadway; and a processor that is coupled to the one or more sensors and that is configured to at least facilitate: determining an initial estimated value of acceleration for the target vehicle, based on the one or more indications pertaining to the target vehicle; and controlling a vehicle action for the host vehicle based at least in part on the initial estimated value of the acceleration based on the one or more indications pertaining to the target vehicle.

Also in an exemplary embodiment, the one or more sensors includes a camera configured to obtain cameras images as to one or more brake lights of the target vehicle; and the processor is configured to at least facilitate determining the initial estimated value of acceleration for the target vehicle, and control the vehicle action, based on the brake lights of the target vehicle.

Also in an exemplary embodiment, the processor is configured to at least facilitate controlling a longitudinal acceleration of the host vehicle based on the initial estimated value of acceleration for the target vehicle.

In another exemplary embodiment, a vehicle is provided that includes: a body; a propulsion system configured to generate movement of the body; one or more sensors that are configured to at least facilitate obtaining sensor data with one or more indications pertaining to a target vehicle that is travelling ahead of the vehicle along a roadway; and a processor that is coupled to the one or more sensors and that is configured to at least facilitate: determining an initial estimated value of acceleration for the target vehicle, based on the one or more indications pertaining to the target vehicle; and controlling a vehicle action for the vehicle based at least in part on the initial estimated value of the acceleration based on the one or more indications pertaining to the target vehicle.

Also in an exemplary embodiment, the one or more sensors includes a camera configured to obtain cameras images as to one or more brake lights of the target vehicle; and the processor is configured to at least facilitate determining the initial estimated value of acceleration for the target vehicle, and control the vehicle action, based on the brake lights of the target vehicle.

Also in exemplary embodiment, the processor is configured to at least facilitate controlling a longitudinal acceleration of the vehicle based on the initial estimated value of acceleration for the target vehicle.

In another exemplary embodiment, a vehicle is provided that includes: a body; a propulsion system configured to generate movement of the body; one or more sensors that are configured to at least facilitate obtaining sensor data with one or more indications pertaining to a target vehicle that is travelling ahead of the vehicle along a roadway; and a processor that is coupled to the one or more sensors and that is configured to at least facilitate: determining an initial estimated value of acceleration for the target vehicle, based on the one or more indications pertaining to the target vehicle; and controlling a vehicle action for the vehicle based at least in part on the initial estimated value of the acceleration based on the one or more indications pertaining to the target vehicle.

Also in an exemplary embodiment: the one or more sensors includes a camera configured to obtain cameras images as to one or more brake lights of the target vehicle; and the processor is configured to at least facilitate determining the initial estimated value of acceleration for the target vehicle, and control the vehicle action, based on the brake lights of the target vehicle.

Also in an exemplary embodiment, the processor is configured to at least facilitate controlling a longitudinal acceleration of the vehicle based on the initial estimated value of acceleration for the target vehicle.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle having a control system for controlling one or more functions of the vehicle based on target vehicles in front of the vehicle, in accordance with exemplary embodiments;

FIG. 2 is a diagram of a vehicle, such as the vehicle of FIG. 1, depicted behind a target vehicle, in accordance with exemplary embodiments;

FIG. 3 is a flowchart of a process for controlling a vehicle based on a target vehicle in front of the vehicle, and that can be implemented in connection with the vehicle of FIGS. 1 and 2, in accordance with exemplary embodiments; and

FIG. 4 is an exemplary implementation of the process of FIG. 3, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

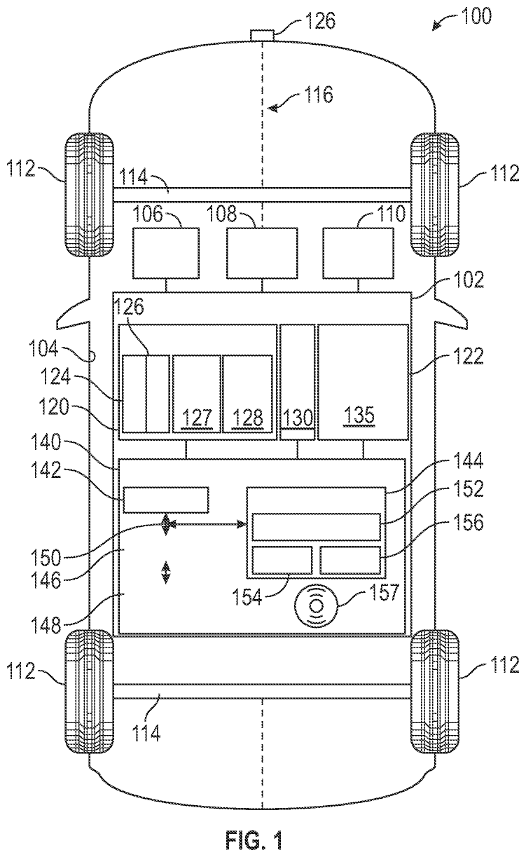

FIG. 1 illustrates a vehicle 100. In various embodiments, and as described below, the vehicle 100 includes a control system 102 for controlling one or more functions of the vehicle 100, including acceleration thereof, based on information for one or more target vehicles travelling along a roadway in front of the vehicle 100. In various embodiments, the vehicle 100 may also be referred to herein as a “host vehicle” (e.g. as differentiation from other vehicles, referenced as “target vehicles”, on the roadway).

In various embodiments, the vehicle 100 comprises an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise a motorcycle or other vehicle, such as aircraft, spacecraft, watercraft, and so on, and/or one or more other types of mobile platforms (e.g., a robot and/or other mobile platform).

The vehicle 100 includes a body 104 that is arranged on a chassis 116. The body 104 substantially encloses other components of the vehicle 100. The body 104 and the chassis 116 may jointly form a frame. The vehicle 100 also includes a plurality of wheels 112. The wheels 112 are each rotationally coupled to the chassis 116 near a respective corner of the body 104 to facilitate movement of the vehicle 100. In one embodiment, the vehicle 100 includes four wheels 112, although this may vary in other embodiments (for example for trucks and certain other vehicles).

A drive system 110 is mounted on the chassis 116, and drives the wheels 112, for example via axles 114. The drive system 110 preferably comprises a propulsion system. In certain exemplary embodiments, the drive system 110 comprises an internal combustion engine and/or an electric motor/generator, coupled with a transmission thereof. In certain embodiments, the drive system 110 may vary, and/or two or more drive systems 112 may be used. By way of example, the vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

In various embodiments, the vehicle 100 includes one or more functions controlled automatically via the control system 102. In certain embodiments, the vehicle 100 comprises an autonomous vehicle, such as a semi-autonomous vehicle or a fully autonomous vehicle. However, this may vary in other embodiments.

As depicted in FIG. 1, the vehicle also includes a braking system 106 and a steering system 108 in various embodiments. In exemplary embodiments, the braking system 106 controls braking of the vehicle 100 using braking components that are controlled via inputs provided by a driver (e.g., via a braking pedal in certain embodiments) and/or automatically via the control system 102. Also in exemplary embodiments, the steering system 108 controls steering of the vehicle 100 via steering components (e.g., a steering column coupled to the axles 114 and/or the wheels 112) that are controlled via inputs provided by a driver (e.g., via a steering wheel in certain embodiments) and/or automatically via the control system 102.

In the embodiment depicted in FIG. 1, the control system 102 is coupled to the braking system 106, the steering system 108, and the drive system 110. Also as depicted in FIG. 1, in various embodiments, the control system 102 includes a sensor array 120, a location system 130, a transceiver 135, and a controller 140.

In various embodiments, the sensor array 120 includes various sensors that obtain sensor data for obtaining information maintaining movement of the vehicle 100 within an appropriate lane of travel. In the depicted embodiment, the sensor array 120 includes one or more vehicle sensors 124 (e.g., one or more wheel speed sensors, vehicle speed sensors, accelerometers, steering angle sensors, and the like), cameras 126, radar sensors 127, and/other sensors 128 (e.g., one or more other advanced driver assistance, or ADAD, sensors). In various embodiments, one or more of the cameras 126, radar sensors 127, and/or other sensors 128 are disposed on the body 104 of the vehicle 100 (e.g., on a front bumper, rooftop, at or near a front windshield, or the like) and face in front of the vehicle 100, and obtain sensor data with respect to another vehicle (hereinafter referenced as a “target vehicle”) in front of the vehicle 100.

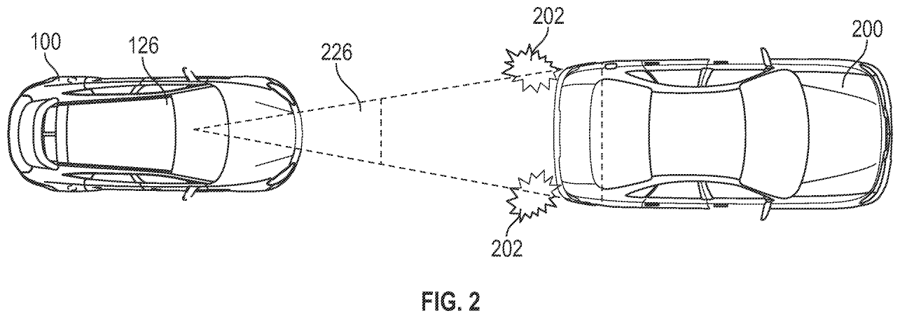

With reference to FIG. 2, in various embodiments, the camera 126 (and/or other sensors) obtain sensor data 226 with respect to target vehicle 200, which is travelling in front of the vehicle (i.e., host vehicle) 100 on the same road or path (collectively referred to herein as a “roadway”). As depicted in FIG. 2, in various embodiments, the camera 126 captures images of brake lights 202 of the target vehicle 200. In various embodiments, the camera 126 (and/or other sensors) may also obtain camera images and/or other sensor data with respect to other indications of the target vehicle 200 (e.g., a turn signal) and/or that otherwise may related to or impact travel of the target vehicle 100 and/or the host vehicle 100 (e.g., a traffic light changing colors, a third vehicle in front of the target vehicle 200 that may be decelerating, and so on).

With reference back to FIG. 1, also in various embodiments, the location system 130 is configured to obtain and/or generate data as to a position and/or location in which the vehicle 100 and the target vehicle 200 are travelling. In certain embodiments, the location system 130 comprises and/or or is coupled to a satellite-based network and/or system, such as a global positioning system (GPS) and/or other satellite-based system.

In certain embodiments, the vehicle 100 also includes a transceiver 135 that communicates with the target vehicle 200 of FIG. 2 and/or with one or more other vehicles and/or other infrastructure on or associated with the roadway. In various embodiments, the transceiver 135 receives information from the target vehicle 200, other vehicles, or other entities (e.g., a traffic camera and/or other vehicle to infrastructure communications), such as whether and when the target vehicle 200 and/or other vehicles (e.g., a third vehicle ahead of the target vehicle) are slowing down or about to slow down, and/or whether a traffic light is about to change color, and so on.

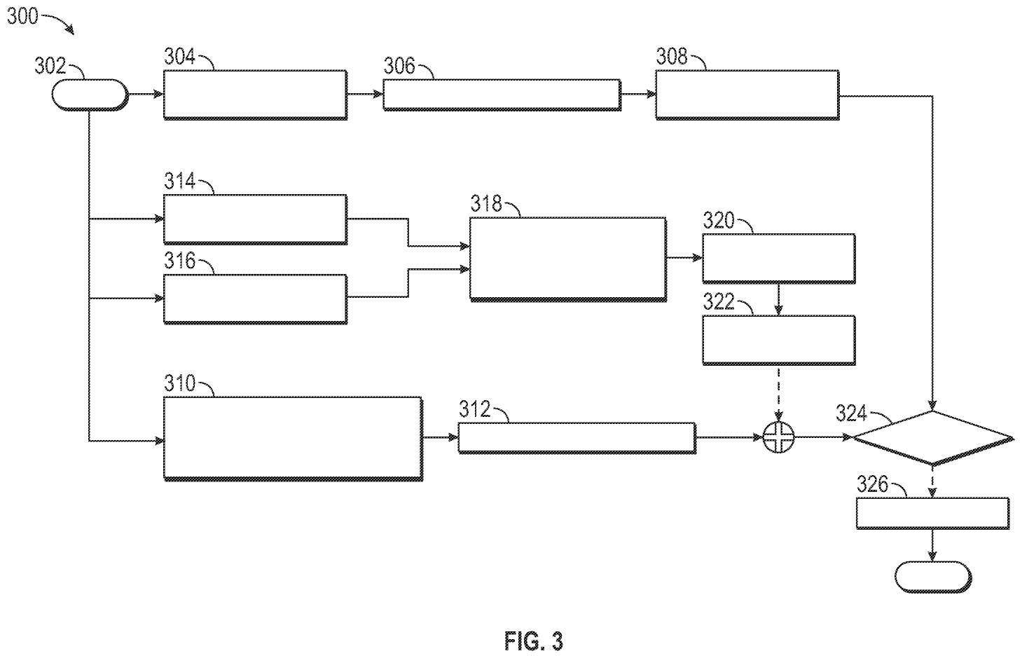

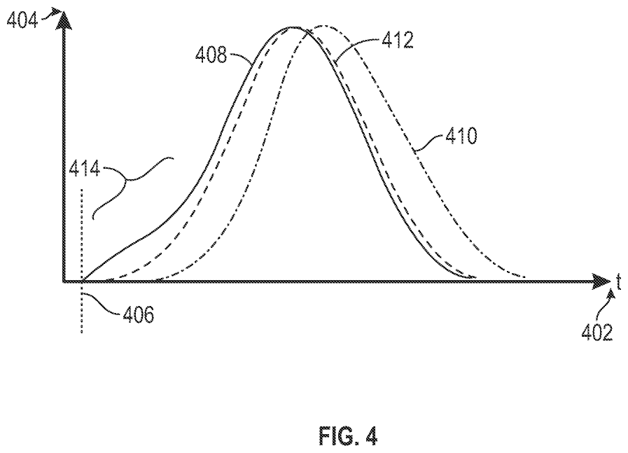

In various embodiments, the controller 140 is coupled to the sensor array 120, the location system 130, and the transceiver 135. Also in various embodiments, the controller 140 comprises a computer system (also referred to herein as computer system 140), and includes a processor 142, a memory 144, an interface 146, a storage device 148, and a computer bus 150. In various embodiments, the controller (or computer system) 140 controls travel of the vehicle 100 (including acceleration thereof) based on the sensor data obtained from the target vehicle 200 of FIG. 2 (and/or, in certain embodiments, from one or more other vehicles on the roadway and/or infrastructure associated with the roadway). In various embodiments, the controller 140 provides these and other functions in accordance with the steps of the process 300 of FIG. 3 and implementations described further below, for example in connection with FIG. 4.

In various embodiments, the controller 140 (and, in certain embodiments, the control system 102 itself) is disposed within the body 104 of the vehicle 100. In one embodiment, the control system 102 is mounted on the chassis 116. In certain embodiments, the controller 104 and/or control system 102 and/or one or more components thereof may be disposed outside the body 104, for example on a remote server, in the cloud, or other device where image processing is performed remotely.

It will be appreciated that the controller 140 may otherwise differ from the embodiment depicted in FIG. 1. For example, the controller 140 may be coupled to or may otherwise utilize one or more remote computer systems and/or other control systems, for example as part of one or more of the above-identified vehicle 100 devices and systems.

In the depicted embodiment, the computer system of the controller 140 includes a processor 142, a memory 144, an interface 146, a storage device 148, and a bus 150. The processor 142 performs the computation and control functions of the controller 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the controller 140 and the computer system of the controller 140, generally in executing the processes described herein, such as the process of FIG. 3 and implementations described further below, for example in connection with FIG. 4.

The memory 144 can be any type of suitable memory. For example, the memory 144 may include various types of dynamic random access memory (DRAM) such as SDRAM, the various types of static RAM (SRAM), and the various types of non-volatile memory (PROM, EPROM, and flash). In certain examples, the memory 144 is located on and/or co-located on the same computer chip as the processor 142. In the depicted embodiment, the memory 144 stores the above-referenced program 152 along with map data 154 (e.g., from and/or used in connection with the location system 130) and one or more stored values 156 (e.g., including, in various embodiments, threshold values with respect to the target vehicle 200 of FIG. 2).

The bus 150 serves to transmit programs, data, status and other information or signals between the various components of the computer system of the controller 140. The interface 146 allows communication to the computer system of the controller 140, for example from a system driver and/or another computer system, and can be implemented using any suitable method and apparatus. In one embodiment, the interface 146 obtains the various data from the sensor array 120 and/or the location system 130. The interface 146 can include one or more network interfaces to communicate with other systems or components. The interface 146 may also include one or more network interfaces to communicate with technicians, and/or one or more storage interfaces to connect to storage apparatuses, such as the storage device 148.

The storage device 148 can be any suitable type of storage apparatus, including various different types of direct access storage and/or other memory devices. In one exemplary embodiment, the storage device 148 comprises a program product from which memory 144 can receive a program 152 that executes one or more embodiments of one or more processes of the present disclosure, such as the steps of the process of FIG. 3 and implementations described further below, for example in connection with FIG. 3. In another exemplary embodiment, the program product may be directly stored in and/or otherwise accessed by the memory 144 and/or a disk (e.g., disk 157), such as that referenced below.

The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 140 may also otherwise differ from the embodiment depicted in FIG. 1, for example in that the computer system of the controller 140 may be coupled to or may otherwise utilize one or more remote computer systems and/or other control systems.

With reference to FIG. 3, a flowchart is provided of a process 300 for controlling a vehicle based on a target vehicle in front of the vehicle, in accordance with exemplary embodiments. The process 300 can be implemented in connection with the vehicle 100 of FIGS. 1 and 2, in accordance with exemplary embodiments. The process 300 is described below in connection with FIG. 3 as well as FIG. 4, which depicts an exemplary implementation of the process 300.

As depicted in FIG. 3, the process 300 begins at step 302. In one embodiment, the process 300 begins when a vehicle drive or ignition cycle begins, for example when a driver or other user approaches or enters the vehicle 100, or when the driver or other user turns on the vehicle and/or an ignition therefor (e.g. by turning a key, engaging a keyfob or start button, and so on). In one embodiment, the steps of the process 300 are performed continuously during operation of the vehicle.

In various embodiments, one or more automatic control features of the vehicle 100 are enables (step 304). In certain embodiments, an adaptive cruise control feature and/or one or more other automatic control features of the vehicle 100 are enabled via instructions provided by the processor 142 of FIG. 1.

Also in various embodiments, a target vehicle is detected (step 306). In certain embodiments, one or more cameras 126 (and/or radar 127 and/or other sensors 128 of FIG. 1) detect a target vehicle (such as the target vehicle 200 of FIG. 2) that is travelling in front of, and along the same roadway as, the vehicle 100.

Also in various embodiments, the automatic vehicle control features of step 304 (e.g., adaptive cruise control and/or other automatic features of the vehicle 100) are engaged (step 308). In various embodiments, during step 308, the processor 142 of FIG. 1 provides instructions for the engagement of the automatic features of the vehicle 100, for example while maintaining a safe distance from the target vehicle 200 (e.g., such that a distance to the target vehicle 200 remains greater than a predetermined threshold and/or a time to contact with the target vehicle 200 remains greater than a predetermined time threshold, and so on).

Also in various embodiments, one or more indications are received with respect to the target vehicle (step 310). In certain embodiments, the cameras 126 detect brake lights of the target vehicle 200 via camera images. In various embodiments, one or more cameras 126 (and/or radar and/or other sensors) may detect brake lights and/or one or more other indications of or pertaining to the target vehicle (e.g., a turn indicator) and/or otherwise along the roadway, such as a third vehicle stopped in front of the target vehicle 200, a turn signal about to change color, or the like. In addition, in certain embodiments, data as to such indications may also be received via the transceiver 135 of FIG. 1 (and/or another transceiver or receiver of the vehicle 100), for example through vehicle to vehicle communications (e.g., between the vehicle 100 and the target vehicle 200 and/or other vehicles) and/or vehicle to infrastructure communications (e.g., between the vehicle 100 and a traffic light and/or other infrastructure along or associated with the roadway).

In various embodiments, an initial calculation of an acceleration of the target vehicle is performed (step 312). In various embodiments, the processor 142 of FIG. 1 performs an initial calculation for an initial estimate for a negative acceleration (i.e., deceleration) of the target vehicle based on the indication(s) received in step 310. For example, in one embodiment in which brake lights of the target vehicle 200 are detected in step 310, the processor 142 determines an initial estimate of the acceleration of the target vehicle in accordance with expected deceleration values associated with target vehicles exhibiting brake lights (e.g., as stored in the memory 144 as stored values 156 thereof based on prior execution of the process 300 and/or prior history and/or reported results, or the like). In other embodiments in which other indications are received detected or received in step 310 (e.g., a turn light indicator, another vehicle slowing down in front of the target vehicle 200, a traffic light about to turn color, and so on), the processor may similarly determine an estimated initial value of the target vehicle acceleration (or deceleration) based on similar historical data with respect to such indications. In various embodiments, the automatic vehicle control (e.g., adaptive cruise control and/or other automatic features) is executed and/or adjusted based on the initial estimate of the acceleration (or deceleration) of the target vehicle 200.

In certain embodiments the acceleration (or deceleration) of the target vehicle is

âₓ(Δt)=bₙΔtⁿ+b₀=Δₖ·B (Equation 1),

wherein

Δ=[Δtⁿ, . . . ,Δt,1] (Equation 2),

in which

$$B = [ \begin{matrix}{b}_{n} \\ ⋮ \\ {b}_{1} \\ {b}_{0}\end{matrix} ]$$

is the predictive coefficient that is based primarily on the indication detected during step 310 (e.g., the brake lights of the target vehicle 200, in one embodiment),

and in which “n” is the prediction dimension to learn the dynamics. In certain embodiments, the default value that is used for proof of concept is “n=1”.

In various embodiments, the time “t” begins with the detection of the indication of step, such as the detection of the brake lights on target vehicle 200 (i.e., t=t₀). Also in various embodiments, at subsequent points in time (i.e., t=t₀+Δt), and as relative states for the target vehicle are ascertained, the matrix “B” is adapted in order capture the vehicle dynamics of the target vehicle, for example as described below.

In various embodiments, environment and vehicle information are obtained (step 314). In various embodiments, various sensor data from the vehicle sensors 124 of FIG. 1 are obtained, including vehicle speed, vehicle acceleration, yaw rate, and the like, pertaining to the vehicle 100.

Also in various embodiments, additional data is obtained pertaining to the target vehicle (step 316). In various embodiments, the additional data pertains to the target vehicle 200 of FIG. 1, and is obtained via the cameras 126, radar 127, and/or other sensors 128 of FIG. 1, and/or in certain embodiments via the transceiver 136 of FIG. 1 (e.g., via vehicle to vehicle communications and/or vehicle to infrastructure communications) as the host vehicle 100 moves closer to the target vehicle 200.

In various embodiments, the data of steps 314 and 316 is utilized to calculate updated parameters for the target vehicle 200 with respect to the host vehicle 100 (step 318). Specifically, in various embodiments, the processor 142 of FIG. 1 utilizes the various data received via the sensors and/or transceiver of steps 314 and 316 in calculating updated values of following distance, longitudinal speed, and longitudinal acceleration between the host vehicle 100 and the target vehicle 200.

In various embodiments, a measurement error model for the target vehicle acceleration is generated (step 320). In various embodiments, the processor 142 of FIG. 1 generates the correction model for longitudinal acceleration of the target vehicle 200 based on the updated parameters of step 318.

In addition, in various embodiments, a correction is generated for the target vehicle acceleration (step 322). In various embodiments, the processor 142 generates a correction for the initial target vehicle 200 longitudinal acceleration estimated in step 312, utilizing the measurement error model of step 320 and an inverse Kalman filter.

Also in various embodiments, the correction of step 322 is applied to the initial target vehicle acceleration estimate of step 312, to thereby generate an updated acceleration value from the target vehicle 200 (step 324). In various embodiments, the processor 142 of FIG. 1 updates the longitudinal acceleration value of the target vehicle 200 accordingly in step 324, for use in adjusting control of one or more automatic control features for the host vehicle 100, for example as described below.

With respect to steps 320-324, in various embodiments the longitudinal acceleration for the target vehicle 200 is adjusted first in accordance with the following equation:

â_{x,k}=Δₖ·B+vₖ (Equation 3),

in which “vₖ” represents measurement noise and uncertainty.

In various embodiments, the matrix “B₀” is initialized based on an offline analysis and mapping (e.g., using data from the location system 130 and the map data 154 stored in the memory 144 of FIG. 1). Also in certain embodiments, the value of B₀ may be populated using a user's study for different vehicles and/or other historical data.

Also in various embodiments, when sufficient accurate data (e.g., from steps 314 and 316), the acceleration prediction model may be updated as follows:

$$[ \begin{matrix}{b}_{n , k} \\ ⋮ \\ {b}_{1 , k} \\ {b}_{0 , k}\end{matrix} ] = [ \begin{matrix}{b}_{n , k - 1} \\ ⋮ \\ {b}_{1 , k - 1} \\ {b}_{0 , k - 1}\end{matrix} ] + {K}_{k} ( {a}_{x , k} - {Δ}_{k} \cdot {B}_{k - 1} ) , \qquad ( Equation 4 )$$

in which “aₓ” represents the true longitudinal acceleration of the target vehicle 200, and in which “Kₖ” represents the Kalman Gain, which is defined in accordance with the following equation:

Kₖ=Pₖ₋₁Δₖ^{T}(ΔₖPₖ₋₁Δₖ^{T}+R)⁻¹ (Equation 5),

and in which “R” represents the noise covariance update, and in which Pₖ is represented in accordance with the following equation:

Pₖ=(1−KₖΔₖ)Pₖ₋₁ (Equation 6).

With reference to FIG. 4, an exemplary implementation is provided with respect to steps 320-324 of the process 300 of FIG. 3. In the graphical representation of FIG. 4, the x-axis 402 represents time “t”, and the y-axis 404 represents negative acceleration (i.e., deceleration).

As depicted in FIG. 4, the indication of step 310 of or related to the target vehicle 200 (e.g., the brake lights of the target vehicle, and/or in certain embodiments one or more other indications such as a turn signal of the target vehicle, stopping or other action of a third vehicle in front of the target vehicle, a traffic light changing color, and/or one or more other indications) is detected at 406, and an original estimate is 406 is generated based on the indication of step 310. Also as depicted in FIG. 4, a correction 414 is provided to the sensor based estimate 410, generating a corrected estimate 408 based on camera and/or other data of steps 314 and/or 316 and/or steps 310/312, thereby converging with the true measurement 412 of the longitudinal acceleration of the target vehicle 200.

As shown in FIG. 4, this process (including the relatively early detection of the brake lights or other indication of step 310, before other data becomes available) generates an accurate estimate of the longitudinal acceleration of the target vehicle 200 more rapidly as compared with estimates using the data of steps 314 and 316 along (i.e., shown as reported values 410 of FIG. 4). This allows for the host vehicle 100 to react more quickly to the target vehicle 200's deceleration, in implementing and/or adjusting automatic control features of the host vehicle 100.

With reference back to FIG. 3, one or more vehicle control actions are engaged and/or adjusted (step 326). In various embodiments, the processor 142 of FIG. 1 provides instructions for implementation and/or adjustment of one or more vehicle control actions in controlling and/or adjusting a longitudinal acceleration and/or speed of the host vehicle 100, as implemented via the drive system 110 (e.g., by reducing throttle) and/or the braking system 106 (e.g., by applying braking) of FIG. 1. In certain embodiments, the vehicle control actions are performed via an adaptive cruise control operation of the vehicle 100 and/or autonomous operation of the vehicle 100. The adaptive cruise control actions can be realized by the drive system 110 and/or the braking system 106. In addition, in certain embodiments, one or more other vehicle control actions may be taken, such as via instructions provided to the steering system 108 and/or via one or more other vehicle systems.

Accordingly, methods, systems, and vehicles are provided for control of automatic functionality of a vehicle. In various embodiments, a brake light or other indication of a target vehicle is detected via a camera or other sensor of the host vehicle, and this information is utilized to control automatic functionality of the host vehicle, such as a vehicle speed and longitudinal acceleration of the host vehicle.

In various embodiments, this allows the host vehicle to adjust more quickly and accurately to deceleration in the target vehicle, for example because the brake light or other indication is obtained prior to other information regarding the target vehicle (such as, for example, measured acceleration values of the target vehicle). Also in various embodiments, this allows a more “human-like” experience, for example as the automatic control feature may be calibrated to mimic the behavior of a human driver (e.g., when a human driver takes his or her foot off the accelerator pedal upon seeing brake lights ahead, and so on).

In various embodiments, the techniques described herein may be used in connection with vehicles having a human driver, but that also have automatic functionality (e.g., adaptive cruise control). In various embodiments, the techniques described herein may also be used in connection autonomous vehicles, such as semi-autonomous and/or fully autonomous vehicles.

It will be appreciated that the systems, vehicles, and methods may vary from those depicted in the Figures and described herein. For example, the vehicle 100 of FIG. 1 may differ from that depicted in FIGS. 1 and 2. It will similarly be appreciated that the steps of the process 300 may differ from those depicted in FIG. 3, and/or that various steps of the process 300 may occur concurrently and/or in a different order than that depicted in FIG. 3. It will similarly be appreciated that the various implementation of FIG. 4 may also differ in various embodiments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof

What is claimed is:

1. A method comprising:
obtaining, via one or more sensors of a host vehicle, one or more indications pertaining to a target vehicle that is travelling ahead of the host vehicle along a roadway;
determining, via a processor of the host vehicle, an initial estimated value of acceleration and states for the target vehicle, based on the one or more indications pertaining to the target vehicle; and
controlling, via instructions provided by the processor, a vehicle action for the host vehicle based at least in part on the initial estimated value of the acceleration and other states of the vehicle based on the one or more indications pertaining to the target vehicle.

2. The method of claim 1, wherein the step of obtaining the one or more indications comprises:
obtaining the one or more indications based on camera images from a camera onboard the host vehicle.

3. The method of claim 2, wherein:
the step of obtaining the one or more indications comprises obtaining cameras images, from the camera onboard the host vehicle, as to one or more brake lights of the target vehicle; and
the step of determining the initial estimated value of acceleration for the target vehicle comprises determining the initial estimated value of acceleration for the target vehicle based on the brake lights of the target vehicle.

4. The method of claim 1, wherein the step of obtaining the one or more indications comprises:
obtaining the one or more indications based on vehicle to vehicle communications between the host vehicle and one or more other vehicles.

5. The method of claim 1, wherein the step of obtaining the one or more indications comprises:
obtaining the one or more indications based on vehicle to vehicle to infrastructure communications between the host vehicle and one or more infrastructure components of the roadway.

6. The method of claim 1, wherein:
the step of obtaining the one or more indications comprises obtaining information as to a signal provided by the target vehicle; and
the step of determining the initial estimated value of acceleration for the target vehicle comprises determining the initial estimated value of acceleration for the target vehicle based on the signal provided by the target vehicle.

7. The method of claim 6, wherein:
the step of obtaining the one or more indications comprises obtaining information as to a turn signal provided by the target vehicle; and
the step of determining the initial estimated value of acceleration for the target vehicle comprises determining the initial estimated value of acceleration for the target vehicle based on the turn signal provided by the target vehicle.

8. The method of claim 1, wherein:
the step of obtaining the one or more indications comprises information pertaining to a traffic signal in proximity to the target vehicle; and
the step of determining the initial estimated value of acceleration for the target vehicle comprises determining the initial estimated value of acceleration for the target vehicle based on the traffic signal.

9. The method of claim 1, wherein:
the step of obtaining the one or more indications comprises information pertaining to a traffic signal in proximity to the target vehicle; and
the step of determining the initial estimated value of acceleration for the target vehicle comprises determining the initial estimated value of acceleration for the target vehicle based on the traffic signal.

10. The method of claim 1, wherein:
the step of obtaining the one or more indications comprises information pertaining to an additional vehicle in front of the target vehicle along the roadway; and
the step of determining the initial estimated value of acceleration for the target vehicle comprises determining the initial estimated value of acceleration for the target vehicle based on the information pertaining to the additional vehicle.

11. The method of claim 1, wherein the step of controlling the vehicle action comprises:
controlling, via the processor, a longitudinal acceleration of the host vehicle based on the initial estimated value of acceleration for the target vehicle.

12. The method of claim 11, wherein the step of controlling the longitudinal acceleration comprises:
controlling, via the processor, the longitudinal acceleration of the host vehicle as part of an adaptive cruise control functionality of the host vehicle based on initial estimated value of acceleration for the target vehicle.

13. The method of claim 1, further comprising:
receiving updated sensor data with respect to the target vehicle via one or more additional sensors of the host vehicle;
applying, via the processor, a correction to the initial estimated value of acceleration for the target vehicle, based on the updated sensor data; and
controlling, via the instructions provided by the processor, the vehicle action based on the correction to the initial estimated value of acceleration for the target vehicle.

14. The method of claim 1, wherein the step controlling the vehicle action comprises controlling the vehicle action, via the instructions provided by the processor, based on the initial value of acceleration of the target vehicle, in a manner that mimics a human driver.

15. A system comprising:
one or more sensors of a host vehicle that are configured to at least facilitate obtaining sensor data with one or more indications pertaining to a target vehicle that is travelling ahead of the host vehicle along a roadway; and
a processor that is coupled to the one or more sensors and that is configured to at least facilitate:
determining an initial estimated value of acceleration for the target vehicle, based on the one or more indications pertaining to the target vehicle; and
controlling a vehicle action for the host vehicle based at least in part on the initial estimated value of the acceleration based on the one or more indications pertaining to the target vehicle.

16. The system of claim 15, wherein:
the one or more sensors comprises a camera configured to obtain cameras images as to one or more brake lights of the target vehicle; and
the processor is configured to at least facilitate determining the initial estimated value of acceleration for the target vehicle, and control the vehicle action, based on the brake lights of the target vehicle.

17. The system of claim 16, wherein the processor is configured to at least facilitate controlling a longitudinal acceleration of the host vehicle based on the initial estimated value of acceleration for the target vehicle.

18. A vehicle comprising:
a body;
a propulsion system configured to generate movement of the body;
one or more sensors that are configured to at least facilitate obtaining sensor data with one or more indications pertaining to a target vehicle that is travelling ahead of the vehicle along a roadway; and
a processor that is coupled to the one or more sensors and that is configured to at least facilitate:
determining an initial estimated value of acceleration for the target vehicle, based on the one or more indications pertaining to the target vehicle; and
controlling a vehicle action for the vehicle based at least in part on the initial estimated value of the acceleration based on the one or more indications pertaining to the target vehicle.

19. The vehicle of claim 18, wherein:
the one or more sensors comprises a camera configured to obtain cameras images as to one or more brake lights of the target vehicle; and
the processor is configured to at least facilitate determining the initial estimated value of acceleration for the target vehicle, and control the vehicle action, based on the brake lights of the target vehicle.

20. The vehicle of claim 18, wherein the processor is configured to at least facilitate controlling a longitudinal acceleration of the vehicle based on the initial estimated value of acceleration for the target vehicle.
